(19) United States
(12) Patent Application Publication
(10) Pub. No.: US 2003/0054774 A1
(43) Pub. Date: Mar. 20, 2003

(54) Method and system for managing hardware resources to implement system acquisition using an adaptive computing architecture

(75) Inventors: Robert T. Plunkett, Sunnyvale, CA (US); Ghobad Heidari, San Diego, CA (US); Paul L. Master, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Quicksilver Technology, Inc.

(21) Appl. No.: 10/015,544

(22) Filed: Dec. 12, 2001

Related U.S. Application Data
(63) Continuation-in-part of application No. 09/815,122, filed on Mar. 22, 2001.

(51) Int. Cl. H04B 1/40

(52) U.S. Cl. 455/74; 713/1

(57) ABSTRACT

The present invention concerns a new category of integrated circuitry and a new methodology for adaptive or reconfigurable computing. The exemplary IC embodiment includes a plurality of heterogeneous computational elements coupled to an interconnection network. The plurality of heterogeneous computational elements include corresponding computational elements having fixed and differing architectures, such as fixed architectures for different functions such as memory, addition, multiplication, complex multiplication, subtraction, configuration, reconfiguration, control, input, output, and field programmability. In response to configuration information, the interconnection network is operative in real-time to configure and reconfigure the plurality of heterogeneous computational elements for a plurality of different functional modes, including linear algorithmic operations, non-linear algorithmic operations, finite state machine operations, memory operations, and bit-level manipulations. The various fixed architectures are selected to comparatively minimize power consumption and increase performance of the adaptive computing integrated circuit, particularly suitable for mobile, hand-held or other battery-powered computing applications. In an exemplary embodiment, some or all of the computational elements are alternately configured to implement two or more functions including a system acquisition function.

### CROSS-REFERENCES TO RELATED APPLICATIONS

This is a continuation-in-part application of U.S. patent application Ser. No. 09/815,122 entitled “ADAPTIVE INTEGRATED CIRCUITRY WITH HETEROGENEOUS AND RECONFIGURABLE MATRICES OF DIVERSE AND ADAPTIVE COMPUTATIONAL UNITS HAVING FIXED, APPLICATION SPECIFIC COMPUTATIONAL ELEMENTS,” filed on Mar. 22, 2001, the disclosure of which is hereby incorporated by reference in their entirety as if set forth in full herein for all purposes.

### BACKGROUND OF THE INVENTION

The present invention relates, in general, to integrated circuits and, more particularly, to adaptive integrated circuitry with heterogeneous and reconfigurable matrices of diverse and adaptive computational units having fixed, application specific computational elements.

The advances made in the design and development of integrated circuits (“ICs”) have generally produced ICs of several different types or categories having different properties and functions, such as the class of universal Turing machines (including microprocessors and digital signal processors (“DSPs”), application specific integrated circuits (“ASICs”), and field programmable gate arrays (“FPGAs”)). Each of these different types of ICs, and their corresponding design methodologies, have distinct advantages and disadvantages.

Microprocessors and DSPs, for example, typically provide a flexible, software programmable solution for the implementation of a wide variety of tasks. As various technology standards evolve, microprocessors and DSPs may be reprogrammed, to varying degrees, to perform various new or altered functions or operations. Various tasks or algorithms, however, must be partitioned and constrained to fit the physical limitations of the processor, such as bus widths and hardware availability. In addition, as processors are designed for the execution of instructions, large areas of the IC are allocated to instruction processing, with the result that the processors are comparatively inefficient in the performance of actual algorithmic operations, with only a few percent of these operations performed during any given clock cycle. Microprocessors and DSPs, moreover, have a comparatively limited activity factor, such as having only approximately five percent of their transistors engaged in algorithmic operations at any given time, with most of the transistors allocated to instruction processing. As a consequence, for the performance of any given algorithmic operation, processors consume significantly more IC (or silicon) area and consume significantly more power compared to other types of ICs, such as ASICs.

While having comparative advantages in power consumption and size, ASICs provide a fixed, rigid or “hard-wired” implementation of transistors (or logic gates) for the performance of a highly specific task or a group of highly specific tasks. ASICs typically perform these tasks quite effectively, with a comparatively high activity factor, such as with twenty-five to thirty percent of the transistors engaged in switching at any given time. Once etched, however, an ASIC is not readily changeable, with any modification being time-consuming and expensive, effectively requiring new masks and new fabrication. As a further result, ASIC design virtually always has a degree of obsolescence, with a design cycle lagging behind the evolving standards for product implementations. For example, an ASIC designed to implement GSM or CDMA standards for mobile communication becomes relatively obsolete with the advent of a new standard, such as 3G.

FPGAs have evolved to provide some design and programming flexibility, allowing a degree of post-fabrication modification. FPGAs typically consist of small, identical sections or “islands” of programmable logic (logic gates) surrounded by many levels of programmable interconnect, and may include memory elements. FPGAs are homogeneous, with the IC comprised of repeating arrays of identical groups of logic gates, memory and programmable interconnect. A particular function may be implemented by configuring (or reconfiguring) the interconnect to connect the various logic gates in particular sequences and arrangements. The most significant advantage of FPGAs are their post-fabrication reconfigurability, allowing a degree of flexibility in the implementation of changing or evolving specifications or standards. The reconfiguring process for an FPGA is comparatively slow, however, and is typically unsuitable for most real-time, immediate applications.

While this post-fabrication flexibility of FPGAs provides a significant advantage, FPGAs have corresponding and inherent disadvantages. Compared to ASICs, FPGAs are very expensive and very inefficient for implementation of particular functions, and are often subject to a “combinatorial explosion” problem. More particularly, for FPGA implementation, an algorithmic operation comparatively may require orders of magnitude more IC area, time and power, particularly when the particular algorithmic operation is a poor fit to the pre-existing, homogeneous islands of logic gates of the FPGA material. In addition, the programmable interconnect, which should be sufficiently rich and available to provide reconfiguration flexibility, has a correspondingly high capacitance, resulting in comparatively slow operation and high power consumption. For example, compared to an ASIC, an FPGA implementation of a relatively simple function, such as a multiplier, consumes significant IC area and vast amounts of power, while providing significantly poorer performance by several orders of magnitude. In addition, there is a chaotic element to FPGA routing, rendering FPGAs subject to unpredictable routing delays and wasted logic resources, typically with approximately one-half or more of the theoretically available gates remaining unusable due to limitations in routing resources and routing algorithms.

Various prior art attempts to meld or combine these various processor, ASIC and FPGA architectures have had utility for certain limited applications, but have not proven to be successful or useful for low power, high efficiency, and real-time applications. Typically, these prior art attempts have simply provided, on a single chip, an area of known FPGA material (consisting of a repeating array of identical logic gates with interconnect) adjacent to either a processor or an ASIC, with limited interoperability, as an aid to either processor or ASIC functionality. For example, Trimberger U.S. Pat. No. 5,737,631, entitled “Reprogrammable Instruction Set Accelerator”, issued Apr. 7, 1998, is designed to provide instruction acceleration for a general purpose processor, and merely discloses a host CPU made up of such a basic microprocessor combined in parallel with known FPGA material (with an FPGA configuration store, which together form the reprogrammable instruction set accelerator). This reprogrammable instruction set accelerator, while allowing for some post-fabrication reconfiguration flexibility and processor acceleration, is nonetheless subject to the various disadvantages of traditional processors and traditional FPGA material, such as high power consumption and high capacitance, with comparatively low speed, low efficiency and low activity factors.

Tavana et al. U.S. Pat. No. 6,094,065, entitled “Integrated Circuit with Field Programmable and Application Specific Logic Areas”, issued Jul. 25, 2000, is designed to allow a degree of post-fabrication modification of an ASIC, such as for correction of design or other layout flaws, and discloses use of a field programmable gate array in a parallel combination with a mask-defined application specific logic area (i.e., ASIC material). Once again, known FPGA material, consisting of a repeating array of identical logic gates within a rich programmable interconnect, is merely placed adjacent to ASIC material within the same silicon chip. While potentially providing post-fabrication means for “bug fixes” and other error correction, the prior art IC is nonetheless subject to the various disadvantages of traditional ASICs and traditional FPGA material, such as highly limited reprogrammability of an ASIC, combined with high power consumption, comparatively low speed, low efficiency and low activity factors of FPGAs.

As a consequence, it would be desirable to have a new form or type of integrated circuitry which effectively and efficiently combines and maximizes the various advantages of processors, ASICs and FPGAs, while minimizing potential disadvantages.

In addition, due to the disadvantages of many conventional hardware components, such as processors, ASICs and FPGAs, as described above, hardware components used to implement many functions and/or algorithms in a traditional hardware-based system are permanently dedicated to such functions and/or algorithms. In other words, when a particular function and/or algorithm is not utilized, the associated hardware components remain idle. It would be beneficial and more efficient if the idle hardware components can be used to carry out other functions and/or algorithms within the system.

For example, in a traditional cellular phone, during power-up, a large portion of the circuitry within the cellular phone sits idle waiting for the receiver circuitry to perform system acquisition. The amount of acquisition time is directly proportional to the amount of hardware dedicated to the system acquisition task. Traditionally, the dedicated hardware is optimized based on cost trade-off and system acquisition time and is often much closer sized to the needs of the receiver during traffic mode than during system acquisition. As a result, when acquiring a signal in an unknown environment, e.g., the operating channel is different from the last channel used at power-down, the receiver may spend a large amount of time to acquire the new channel. The time necessary to acquire a signal in an unknown environment may range from seconds to minutes. However, since system acquisition is only performed at power-up, long acquisition times in cases where a new system is encountered is considered an acceptable trade-off. Nevertheless, shorter system acquisition times would still be desirable. Hence, it would be desirable to have a new form or type of integrated circuitry which allows hardware resources to be managed or allocated more efficiently so as to enhance the performance of a system.

Moreover, since hardware components in a traditional hardware-based system are permanently dedicated to their associated functions and/or algorithms, adding and implementing new functions and/or algorithms would require adding hardware components. Due to physical limitations, adding hardware components to a system may not be possible. Consequently, it would also be desirable to have a new form or type of integrated circuitry which allows additional functions and/or algorithms to be added and implemented in a system without incurring significant hardware costs.

### SUMMARY OF THE INVENTION

The present invention provides a new form or type of integrated circuitry which effectively and efficiently combines and maximizes the various advantages of processors, ASICs and FPGAs, while minimizing potential disadvantages. In accordance with the present invention, such a new form or type of integrated circuit, referred to as an adaptive computing engine (ACE), is disclosed which provides the programming flexibility of a processor, the post-fabrication flexibility of FPGAs, and the high speed and high utilization factors of an ASIC. The ACE integrated circuitry of the present invention is readily reconfigurable, in real-time, is capable of having corresponding, multiple modes of operation, and further minimizes power consumption while increasing performance, with particular suitability for low power applications, such as for use in hand-held and other battery-powered devices.

The ACE architecture of the present invention, for adaptive or reconfigurable computing, includes a plurality of heterogeneous computational elements coupled to an interconnection network, rather than the homogeneous units of FPGAs. The plurality of heterogeneous computational elements include corresponding computational elements having fixed and differing architectures, such as fixed architectures for different functions such as memory, addition, multiplication, complex multiplication, subtraction, configuration, reconfiguration, control, input, output, and field programmability. In response to configuration information, the interconnection network is operative in real-time to configure and reconfigure the plurality of heterogeneous computational elements for a plurality of different functional modes, including linear algorithmic operations, non-linear algorithmic operations, finite state machine operations, memory operations, and bit-level manipulations.

As illustrated and discussed in greater detail below, the ACE architecture of the present invention provides a single IC, which may be configured and reconfigured in real-time, using these fixed and application specific computation elements, to perform a wide variety of tasks. For example, utilizing differing configurations over time of the same set of heterogeneous computational elements, the ACE architecture may implement functions such as finite impulse response filtering, fast Fourier transformation, discrete cosine transformation, and with other types of computational elements, may implement many other high level processing functions for advanced communications and computing.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a block diagram illustrating an exemplary embodiment of the present invention;

FIG. 2 is a schematic diagram illustrating an exemplary data flow graph in accordance with the present invention;

FIG. 3 is a block diagram illustrating a reconfigurable matrix, a plurality of computation units, and a plurality of computational elements, in accordance with the present invention;

FIG. 4 is a block diagram illustrating, in greater detail, a computational unit of a reconfigurable matrix in accordance with the present invention;

FIGS. 5A through 5E are block diagrams illustrating, in detail, exemplary fixed and specific computational elements, forming computational units, in accordance with the present invention;

FIG. 6 is a block diagram illustrating, in detail, an exemplary multifunction adaptive computational unit having a plurality of different, fixed computational elements, in accordance with the present invention;

FIG. 7 is a block diagram illustrating, in detail, an exemplary adaptive logic processor computational unit having a plurality of fixed computational elements, in accordance with the present invention;

FIG. 8 is a block diagram illustrating, in greater detail, an exemplary core cell of an adaptive logic processor computational unit with a fixed computational element, in accordance with the present invention;

FIG. 9 is a block diagram illustrating, in greater detail, an exemplary fixed computational element of a core cell of an adaptive logic processor computational unit, in accordance with the present invention; and

FIGS. 10-13 are block diagrams respectively illustrating re-allocation and re-configuration of hardware resources in accordance with the present invention.

### DETAILED DESCRIPTION OF THE INVENTION

As indicated above, it would be desirable to have a new form or type of integrated circuitry which effectively and efficiently combines and maximizes the various advantages of processors, ASICs and FPGAs, while minimizing potential disadvantages. In accordance with the present invention, such a new form or type of integrated circuit, referred to as an adaptive computing engine (ACE), is disclosed which provides the programming flexibility of a processor, the post-fabrication flexibility of FPGAs, and the high speed and high utilization factors of an ASIC. The ACE integrated circuitry of the present invention is readily reconfigurable, in real-time, is capable of having corresponding, multiple modes of operation, and further minimizes power consumption while increasing performance, with particular suitability for low power applications.

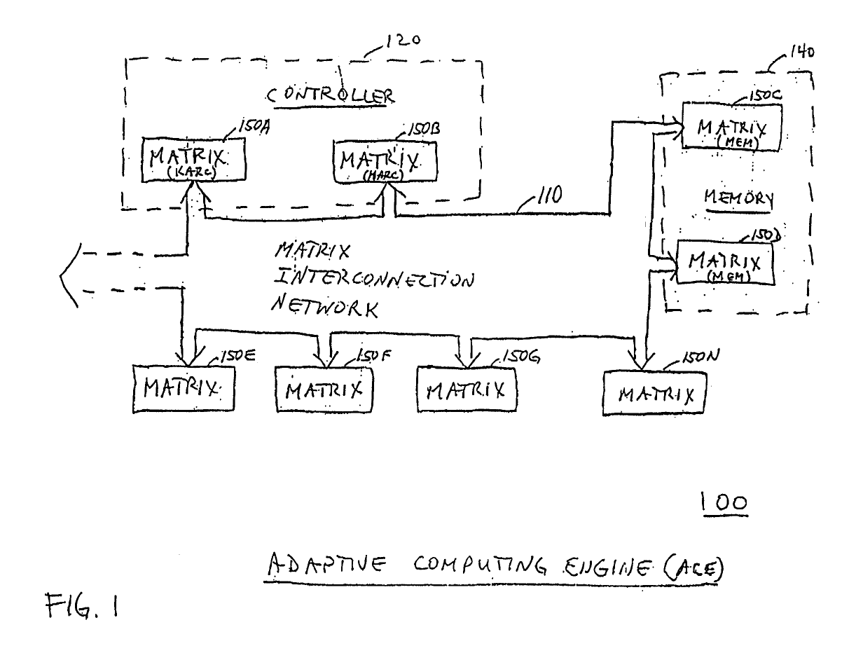

FIG. 1 is a block diagram illustrating an exemplary apparatus 100 embodiment in accordance with the present invention. The apparatus 100, referred to herein as an adaptive computing engine (“ACE”) 100, is preferably embodied as an integrated circuit, or as a portion of an integrated circuit having other, additional components. In the exemplary embodiment, and as discussed in greater detail below, the ACE 100 includes one or more reconfigurable matrices (or nodes)150, such as matrices 150A through 150N as illustrated, and a matrix interconnection network 110. Also in the exemplary embodiment, and as discussed in detail below, one or more of the matrices 150, such as matrices 150A and 150B, are configured for functionality as a controller 120, while other matrices, such as matrices 150C and 150D, are configured for functionality as a memory 140. The various matrices 150 and matrix interconnection network 110 may also be implemented together as fractal subunits, which may be scaled from a few nodes to thousands of nodes.

The ACE 100 does not utilize traditional (and typically separate) data, DMA, random access, configuration and instruction busses for signaling and other transmission between and among the reconfigurable matrices 150, the controller 120, and the memory 140, or for other input/output (“I/O”) functionality. Rather, data, control and configuration information are transmitted between and among these matrix 150 elements, utilizing the matrix interconnection network 110, which may be configured and reconfigured, in real-time, to provide any given connection between and among the reconfigurable matrices 150, including those matrices 150 configured as the controller 120 and the memory 140, as discussed in greater detail below.

The matrices 150 configured to function as memory 140 may be implemented in any desired or exemplary way, utilizing computational elements (discussed below) of fixed memory elements, and may be included within the ACE 100 or incorporated within another IC or portion of an IC. In the exemplary embodiment, the memory 140 is included within the ACE 100, and preferably is comprised of computational elements which are low power consumption random access memory (RAM), but also may be comprised of computational elements of any other form of memory, such as flash, DRAM, SRAM, MRAM, ROM, EPROM or E2PROM. In the exemplary embodiment, the memory 140 preferably includes direct memory access (DMA) engines, not separately illustrated.

The controller 120 is preferably implemented, using matrices 150A and 150B configured as adaptive finite state machines, as a reduced instruction set (“RISC”) processor, controller or other device or IC capable of performing the two types of functionality discussed below. (Alternatively, these functions may be implemented utilizing a conventional RISC or other processor.) The first control functionality, referred to as “kernal” control, is illustrated as kernal controller (“KARC”) of matrix 150A, and the second control functionality, referred to as “matrix” control, is illustrated as matrix controller (“MARC”) of matrix 150B. The kernal and matrix control functions of the controller 120 are explained in greater detail below, with reference to the configurability and reconfigurability of the various matrices 150, and with reference to the exemplary form of combined data, configuration and control information referred to herein as a “silverware” module.

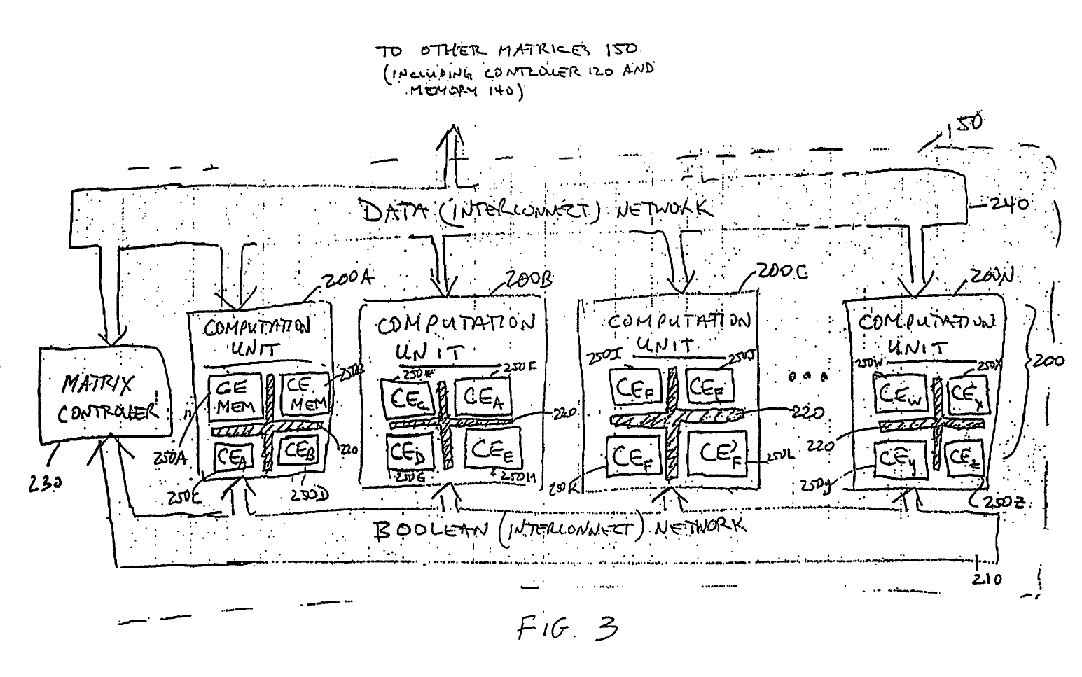

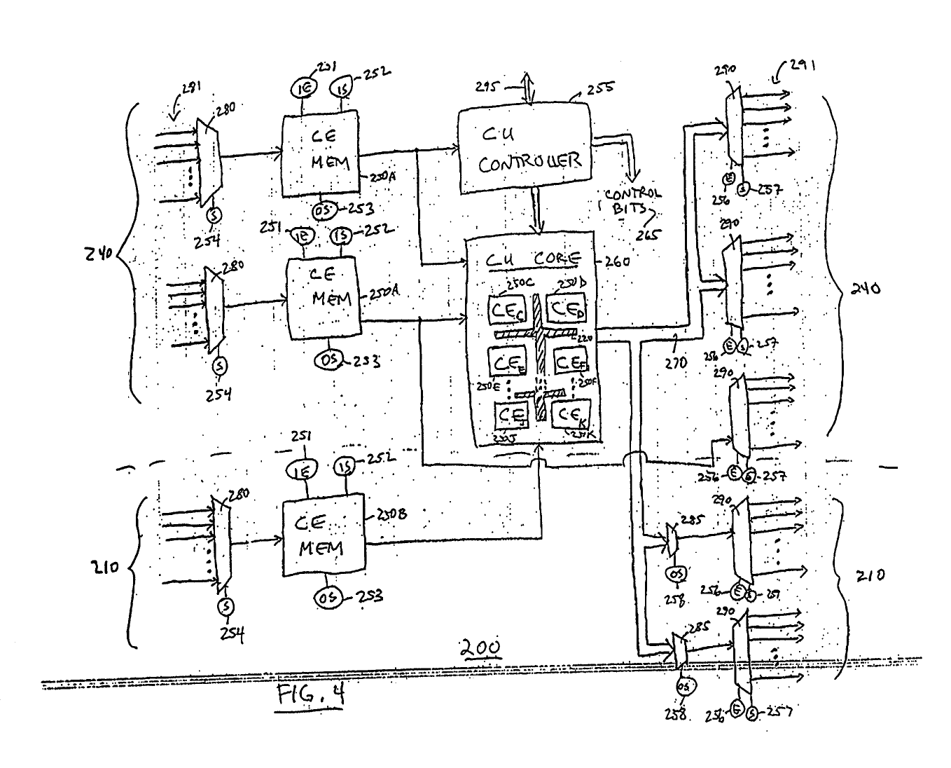

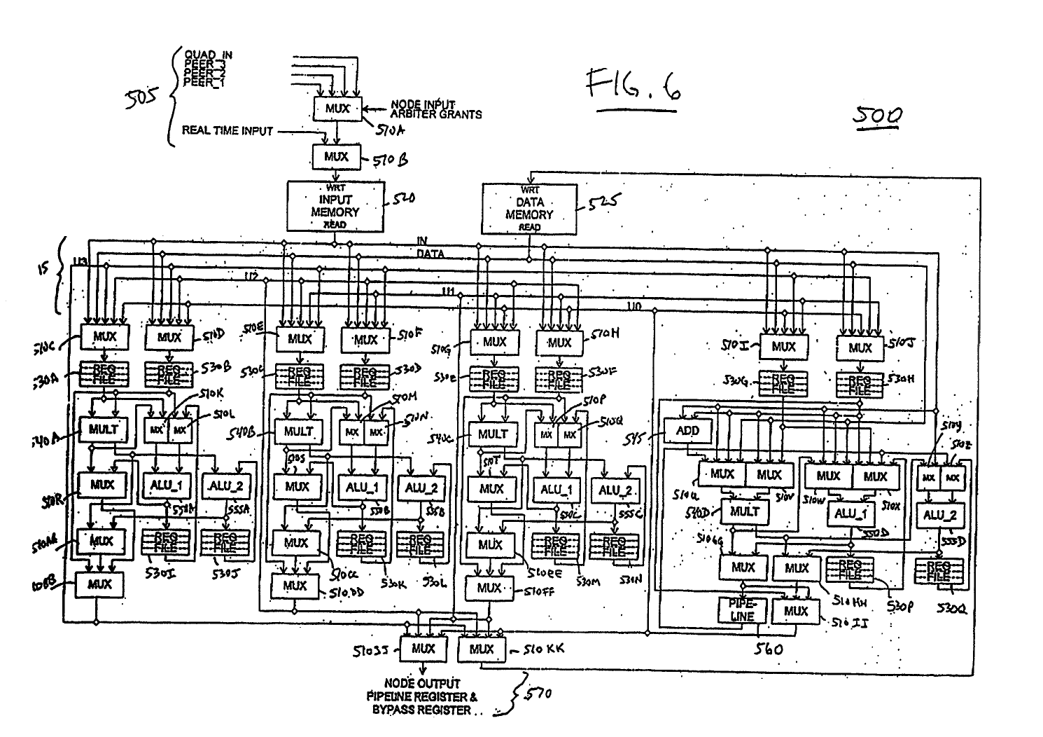

The matrix interconnection network 110 of FIG. 1, and its subset interconnection networks separately illustrated in FIGS. 3 and 4 (Boolean interconnection network 210, data interconnection network 240, and interconnect 220), collectively and generally referred to herein as “interconnect”, “interconnection(s)” or “interconnection network(s)”, may be implemented generally as known in the art, such as utilizing FPGA interconnection networks or switching fabrics, albeit in a considerably more varied fashion. In the exemplary embodiment, the various interconnection networks are implemented as described, for example, in U.S. Pat. No. 5,218,240, U.S. Pat. No. 5,336,950, U.S. Pat. No. 5,245,227, and U.S. Pat. No. 5,144,166, and also as discussed below and as illustrated with reference to FIGS. 7, 8 and 9. These various interconnection networks provide selectable (or switchable) connections between and among the controller 120, the memory 140, the various matrices 150, and the computational units 200 and computational elements 250 discussed below, providing the physical basis for the configuration and reconfiguration referred to herein, in response to and under the control of configuration signaling generally referred to herein as “configuration information”. In addition, the various interconnection networks (110, 210, 240 and 220) provide selectable or switchable data, input, output, control and configuration paths, between and among the controller 120, the memory 140, the various matrices 150, and the computational units 200 and computational elements 250, in lieu of any form of traditional or separate input/output busses, data busses, DMA, RAM, configuration and instruction busses.

It should be pointed out, however, that while any given switching or selecting operation of or within the various interconnection networks (110, 210, 240 and 220) may be implemented as known in the art, the design and layout of the various interconnection networks (110, 210, 240 and 220), in accordance with the present invention, are new and novel, as discussed in greater detail below. For example, varying levels of interconnection are provided to correspond to the varying levels of the matrices 150, the computational units 200, and the computational elements 250, discussed below. At the matrix 150 level, in comparison with the prior art FPGA interconnect, the matrix interconnection network 110 is considerably more limited and less “rich”, with lesser connection capability in a given area, to reduce capacitance and increase speed of operation. Within a particular matrix 150 or computational unit 200, however, the interconnection network (210, 220 and 240) may be considerably more dense and rich, to provide greater adaptation and reconfiguration capability within a narrow or close locality of reference.

The various matrices or nodes 150 are reconfigurable and heterogeneous, namely, in general, and depending upon the desired configuration: reconfigurable matrix 150A is generally different from reconfigurable matrices 150B through 150N; reconfigurable matrix 150B is generally different from reconfigurable matrices 150A and 150C through 150N; reconfigurable matrix 150C is generally different from reconfigurable matrices 150A, 150B and 150D through 150N, and so on. The various reconfigurable matrices 150 each generally contain a different or varied mix of adaptive and reconfigurable computational (or computation) units (200); the computational units 200, in turn, generally contain a different or varied mix of fixed, application specific computational elements (250), discussed in greater detail below with reference to FIGS. 3 and 4, which may be adaptively connected, configured and reconfigured in various ways to perform varied functions, through the various interconnection networks. In addition to varied internal configurations and reconfigurations, the various matrices 150 may be connected, configured and reconfigured at a higher level, with respect to each of the other matrices 150, through the matrix interconnection network 110, also as discussed in greater detail below.

Several different, insightful and novel concepts are incorporated within the ACE 100 architecture of the present invention, and provide a useful explanatory basis for the real-time operation of the ACE 100 and its inherent advantages.

The first novel concepts of the present invention concern the adaptive and reconfigurable use of application specific, dedicated or fixed hardware units (computational elements 250), and the selection of particular functions for acceleration, to be included within these application specific, dedicated or fixed hardware units (computational elements 250) within the computational units 200 (FIG. 3) of the matrices 150, such as pluralities of multipliers, complex multipliers, and adders, each of which are designed for optimal execution of corresponding multiplication, complex multiplication, and addition functions. Given that the ACE 100 is to be optimized, in the exemplary embodiment, for low power consumption, the functions for acceleration are selected based upon power consumption. For example, for a given application such as mobile communication, corresponding C (C+ or C++) or other code may be analyzed for power consumption. Such empirical analysis may reveal, for example, that a small portion of such code, such as 10%, actually consumes 90% of the operating power when executed. In accordance with the present invention, on the basis of such power utilization, this small portion of code is selected for acceleration within certain types of the reconfigurable matrices 150, with the remaining code, for example, adapted to run within matrices 150 configured as controller 120. Additional code may also be selected for acceleration, resulting in an optimization of power consumption by the ACE 100, up to any potential trade-off resulting from design or operational complexity. In addition, as discussed with respect to FIG. 3, other functionality, such as control code, may be accelerated within matrices 150 when configured as finite state machines.

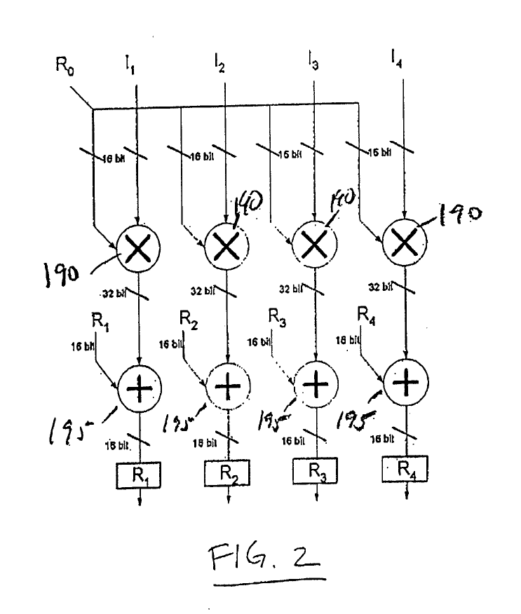

Next, algorithms or other functions selected for acceleration are converted into a form referred to as a “data flow graph” (“DFG”). A schematic diagram of an exemplary data flow graph, in accordance with the present invention, is illustrated in FIG. 2. As illustrated in FIG. 2, an algorithm or function useful for CDMA voice coding (QCELP (Qualcomm code excited linear prediction) is implemented utilizing four multipliers 190 followed by four adders 195. Through the varying levels of interconnect, the algorithms of this data flow graph are then implemented, at any given time, through the configuration and reconfiguration of fixed computational elements (250), namely, implemented within hardware which has been optimized and configured for efficiency, i.e., a “machine” is configured in real-time which is optimized to perform the particular algorithm. Continuing with the exemplary DFG or FIG. 2, four fixed or dedicated multipliers, as computational elements 250, and four fixed or dedicated adders, also as different computational elements 250, are configured in real-time through the interconnect to perform the functions or algorithms of the particular DFG.

The third and perhaps most significant concept of the present invention, and a marked departure from the concepts and precepts of the prior art, is the concept of reconfigurable “heterogeneity” utilized to implement the various selected algorithms mentioned above. As indicated above, prior art reconfigurability has relied exclusively on homogeneous FPGAs, in which identical blocks of logic gates are repeated as an array within a rich, programmable interconnect, with the interconnect subsequently configured to provide connections between and among the identical gates to implement a particular function, albeit inefficiently and often with routing and combinatorial problems. In stark contrast, in accordance with the present invention, within computation units 200, different computational elements (250) are implemented directly as correspondingly different fixed (or dedicated) application specific hardware, such as dedicated multipliers, complex multipliers, and adders. Utilizing interconnect (210 and 220), these differing, heterogeneous computational elements (250) may then be adaptively configured, in real-time, to perform the selected algorithm, such as the performance of discrete cosine transformations often utilized in mobile communications. For the data flow graph example of FIG. 2, four multipliers and four adders will be configured, i.e., connected in real-time, to perform the particular algorithm. As a consequence, in accordance with the present invention, different (“heterogeneous”) computational elements (250) are configured and reconfigured, at any given time, to optimally perform a given algorithm or other function. In addition, for repetitive functions, a given instantiation or configuration of computational elements may also remain in place over time, i.e., unchanged, throughout the course of such repetitive calculations.

The temporal nature of the ACE 100 architecture should also be noted. At any given instant of time, utilizing different levels of interconnect (110, 210, 240 and 220), a particular configuration may exist within the ACE 100 which has been optimized to perform a given function or implement a particular algorithm. At another instant in time, the configuration may be changed, to interconnect other computational elements (250) or connect the same computational elements 250 differently, for the performance of another function or algorithm. Two important features arise from this temporal reconfigurability. First, as algorithms may change over time to, for example, implement a new technology standard, the ACE 100 may co-evolve and be reconfigured to implement the new algorithm. For a simplified example, a fifth multiplier and a fifth adder may be incorporated into the DFG of FIG. 2 to execute a correspondingly new algorithm, with additional interconnect also potentially utilized to implement any additional bussing functionality. Second, because computational elements are interconnected at one instant in time, as an instantiation of a given algorithm, and then reconfigured at another instant in time for performance of another, different algorithm, gate (or transistor) utilization is maximized, providing significantly better performance than the most efficient ASICs relative to their activity factors.

This temporal reconfigurability of computational elements 250, for the performance of various different algorithms, also illustrates a conceptual distinction utilized herein between configuration and reconfiguration, on the one hand, and programming or reprogrammability, on the other hand. Typical programmability utilizes a pre-existing group or set of functions, which may be called in various orders, over time, to implement a particular algorithm. In contrast, configurability and reconfigurability, as used herein, includes the additional capability of adding or creating new functions which were previously unavailable or non-existent.

Next, the present invention also utilizes a tight coupling (or interdigitation) of data and configuration (or other control) information, within one, effectively continuous stream of information. This coupling or commingling of data and configuration information, referred to as a “silverware” module, is the subject of a separate, related patent application. For purposes of the present invention, however, it is sufficient to note that this coupling of data and configuration information into one information (or bit) stream helps to enable real-time reconfigurability of the ACE 100, without a need for the (often unused) multiple, overlaying networks of hardware interconnections of the prior art. For example, as an analogy, a particular, first configuration of computational elements at a particular, first period of time, as the hardware to execute a corresponding algorithm during or after that first period of time, may be viewed or conceptualized as a hardware analog of “calling” a subroutine in software which may perform the same algorithm. As a consequence, once the configuration of the computational elements has occurred (i.e., is in place), as directed by the configuration information, the data for use in the algorithm is immediately available as part of the silverware module. The same computational elements may then be reconfigured for a second period of time, as directed by second configuration information, for execution of a second, different algorithm, also utilizing immediately available data. The immediacy of the data, for use in the configured computational elements, provides a one or two clock cycle hardware analog to the multiple and separate software steps of determining a memory address and fetching stored data from the addressed registers. This has the further result of additional efficiency, as the configured computational elements may execute, in comparatively few clock cycles, an algorithm which may require orders of magnitude more clock cycles for execution if called as a subroutine in a conventional microprocessor or DSP.

This use of silverware modules, as a commingling of data and configuration information, in conjunction with the real-time reconfigurability of a plurality of heterogeneous and fixed computational elements 250 to form adaptive, different and heterogenous computation units 200 and matrices 150, enables the ACE 100 architecture to have multiple and different modes of operation. For example, when included within a handheld device, given a corresponding silverware module, the ACE 100 may have various and different operating modes as a cellular or other mobile telephone, a music player, a pager, a personal digital assistant, and other new or existing functionalities. In addition, these operating modes may change based upon the physical location of the device; for example, when configured as a CDMA mobile telephone for use in the United States, the ACE 100 may be reconfigured as a GSM mobile telephone for use in Europe.

Referring again to FIG. 1, the functions of the controller 120 (preferably matrix (KARC) 150A and matrix (MARC) 150B, configured as finite state machines) may be explained with reference to a silverware module, namely, the tight coupling of data and configuration information within a single stream of information, with reference to multiple potential modes of operation, with reference to the reconfigurable matrices 150, and with reference to the reconfigurable computation units 200 and the computational elements 150 illustrated in FIG. 3. As indicated above, through a silverware module, the ACE 100 may be configured or reconfigured to perform a new or additional function, such as an upgrade to a new technology standard or the addition of an entirely new function, such as the addition of a music function to a mobile communication device. Such a silverware module may be stored in the matrices 150 of memory 140, or may be input from an external (wired or wireless) source through, for example, matrix interconnection network 110. In the exemplary embodiment, one of the plurality of matrices 150 is configured to decrypt such a module and verify its validity, for security purposes. Next, prior to any configuration or reconfiguration of existing ACE 100 resources, the controller 120, through the matrix (KARC) 150A, checks and verifies that the configuration or reconfiguration may occur without adversely affecting any pre-existing functionality, such as whether the addition of music functionality would adversely affect pre-existing mobile communications functionality. In the exemplary embodiment, the system requirements for such configuration or reconfiguration are included within the silverware module, for use by the matrix (KARC) 150A in performing this evaluative function. If the configuration or reconfiguration may occur without such adverse affects, the silverware module is allowed to load into the matrices 150 of memory 140, with the matrix (KARC) 150A setting up the DMA engines within the matrices 150C and 150D of the memory 140 (or other stand-alone DMA engines of a conventional memory). If the configuration or reconfiguration would or may have such adverse affects, the matrix (KARC) 150A does not allow the new module to be incorporated within the ACE 100.

Continuing to refer to FIG. 1, the matrix (MARC) 150B manages the scheduling of matrix 150 resources and the timing of any corresponding data, to synchronize any configuration or reconfiguration of the various computational elements 250 and computation units 200 with any corresponding input data and output data. In the exemplary embodiment, timing information is also included within a silverware module, to allow the matrix (MARC) 150B through the various interconnection networks to direct a reconfiguration of the various matrices 150 in time, and preferably just in time, for the reconfiguration to occur before corresponding data has appeared at any inputs of the various reconfigured computation units 200. In addition, the matrix (MARC) 150B may also perform any residual processing which has not been accelerated within any of the various matrices 150. As a consequence, the matrix (MARC) 150B may be viewed as a control unit which “calls” the configurations and reconfigurations of the matrices 150, computation units 200 and computational elements 250, in real-time, in synchronization with any corresponding data to be utilized by these various reconfigurable hardware units, and which performs any residual or other control processing. Other matrices 150 may also include this control functionality, with any given matrix 150 capable of calling and controlling a configuration and reconfiguration of other matrices 150.

FIG. 3 is a block diagram illustrating, in greater detail, a reconfigurable matrix 150 with a plurality of computation units 200 (illustrated as computation units 200A through 200N), and a plurality of computational elements 250 (illustrated as computational elements 250A through 250Z), and provides additional illustration of the exemplary types of computational elements 250 and a useful summary of the present invention. As illustrated in FIG. 3, any matrix 150 generally includes a matrix controller 230, a plurality of computation (or computational) units 200, and as logical or conceptual subsets or portions of the matrix interconnect network 110, a data interconnect network 240 and a Boolean interconnect network 210. As mentioned above, in the exemplary embodiment, at increasing “depths” within the ACE 100 architecture, the interconnect networks become increasingly rich, for greater levels of adaptability and reconfiguration. The Boolean interconnect network 210, also as mentioned above, provides the reconfiguration and data interconnection capability between and among the various computation units 200, and is preferably small (i.e., only a few bits wide), while the data interconnect network 240 provides the reconfiguration and data interconnection capability for data input and output between and among the various computation units 200, and is preferably comparatively large (i.e., many bits wide). It should be noted, however, that while conceptually divided into reconfiguration and data capabilities, any given physical portion of the matrix interconnection network 110, at any given time, may be operating as either the Boolean interconnect network 210, the data interconnect network 240, the lowest level interconnect 220 (between and among the various computational elements 250), or other input, output, or connection functionality.

Continuing to refer to FIG. 3, included within a computation unit 200 are a plurality of computational elements 250, illustrated as computational elements 250A through 250Z (individually and collectively referred to as computational elements 250), and additional interconnect 220. The interconnect 220 provides the reconfigurable interconnection capability and input/output paths between and among the various computational elements 250. As indicated above, each of the various computational elements 250 consist of dedicated, application specific hardware designed to perform a given task or range of tasks, resulting in a plurality of different, fixed computational elements 250. Utilizing the interconnect 220, the fixed computational elements 250 may be reconfigurably connected together into adaptive and varied computational units 200, which also may be further reconfigured and interconnected, to execute an algorithm or other function, at any given time, such as the quadruple multiplications and additions of the DFG of FIG. 2, utilizing the interconnect 220, the Boolean network 210, and the matrix interconnection network 110.

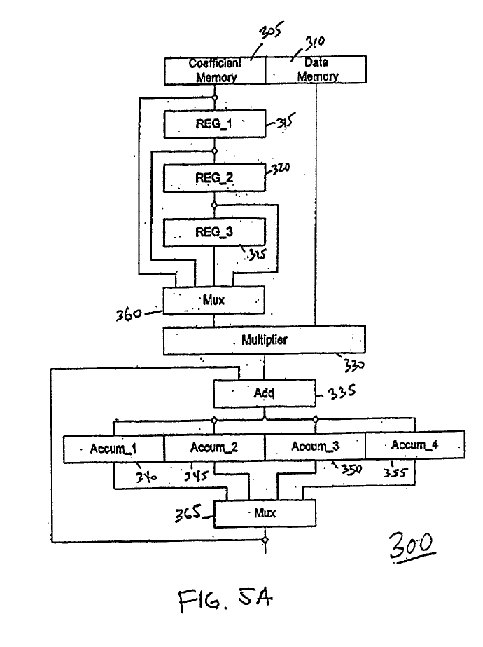

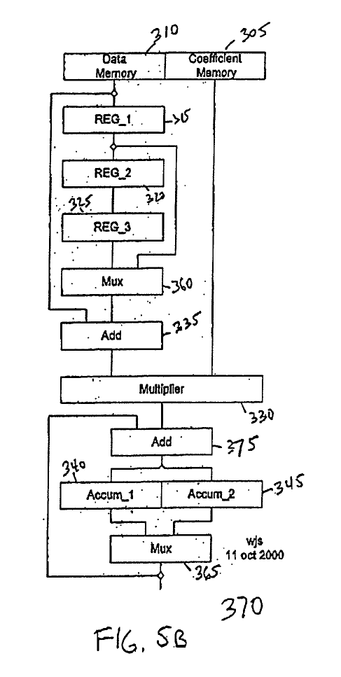

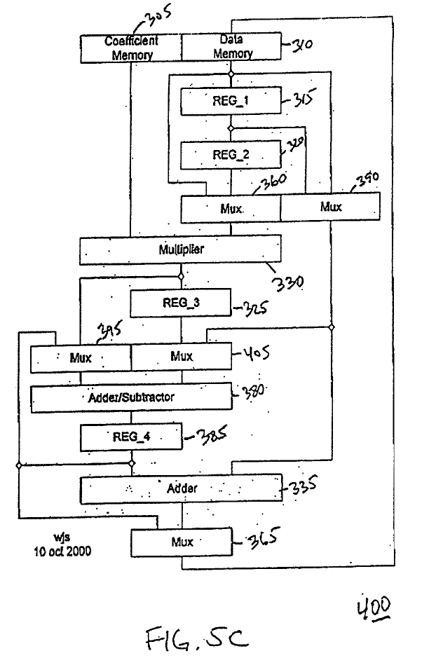

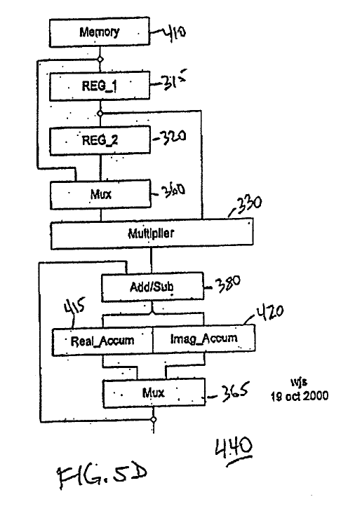

In the exemplary embodiment, the various computational elements 250 are designed and grouped together, into the various adaptive and reconfigurable computation units 200 (as illustrated, for example, in FIGS. 5A through 9). In addition to computational elements 250 which are designed to execute a particular algorithm or function, such as multiplication or addition, other types of computational elements 250 are also utilized in the exemplary embodiment. As illustrated in FIG. 3, computational elements 250A and 250B implement memory, to provide local memory elements for any given calculation or processing function (compared to the more “remote” memory 140). In addition, computational elements 2501, 250J, 250K and 250L are configured to implement finite state machines (using, for example, the computational elements illustrated in FIGS. 7, 8 and 9), to provide local processing capability (compared to the more “remote” matrix (MARC) 150B), especially suitable for complicated control processing.

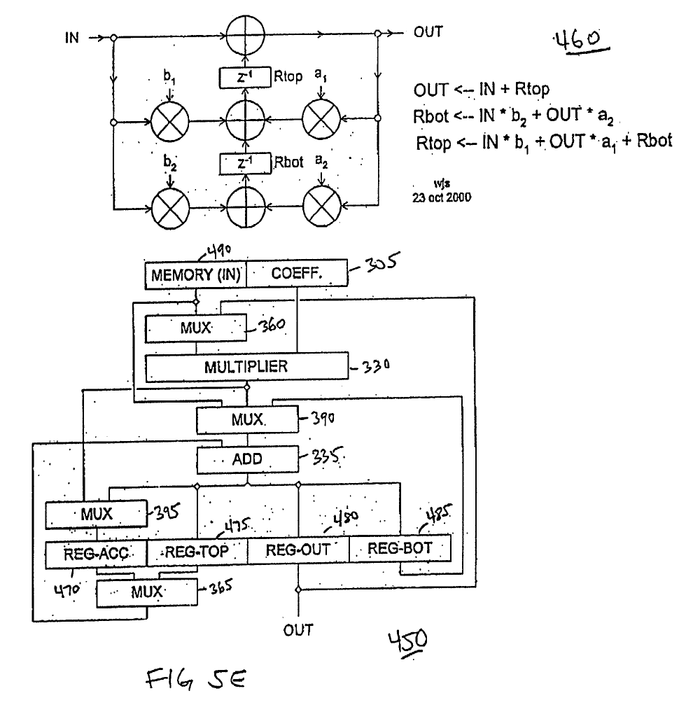

With the various types of different computational elements 250 which may be available, depending upon the desired functionality of the ACE 100, the computation units 200 may be loosely categorized. A first category of computation units 200 includes computational elements 250 performing linear operations, such as multiplication, addition, finite impulse response filtering, and so on (as illustrated below, for example, with reference to FIGS. 5A through 5E and FIG. 6). A second category of computation units 200 includes computational elements 250 performing non-linear operations, such as discrete cosine transformation, trigonometric calculations, and complex multiplications. A third type of computation unit 200 implements a finite state machine, such as computation unit 200C as illustrated in FIG. 3 and as illustrated in greater detail below with respect to FIGS. 7 through 9), particularly useful for complicated control sequences, dynamic scheduling, and input/output management, while a fourth type may implement memory and memory management, such as computation unit 200A as illustrated in FIG. 3. Lastly, a fifth type of computation unit 200 may be included to perform bit-level manipulation, such as for encryption, decryption, channel coding, Viterbi decoding, and packet and protocol processing (such as Internet Protocol processing).

In the exemplary embodiment, in addition to control from other matrices or nodes 150, a matrix controller 230 may also be included within any given matrix 150, also to provide greater locality of reference and control of any reconfiguration processes and any corresponding data manipulations. For example, once a reconfiguration of computational elements 250 has occurred within any given computation unit 200, the matrix controller 230 may direct that that particular instantiation (or configuration) remain intact for a certain period of time to, for example, continue repetitive data processing for a given application.

FIG. 4 is a block diagram illustrating, in greater detail, an exemplary or representative computation unit 200 of a reconfigurable matrix 150 in accordance with the present invention. As illustrated in FIG. 4, a computation unit 200 typically includes a plurality of diverse, heterogeneous and fixed computational elements 250, such as a plurality of memory computational elements 250A and 250B, and forming a computational unit (“CU”) core 260, a plurality of algorithmic or finite state machine computational elements 250C through 250K. As discussed above, each computational element 250, of the plurality of diverse computational elements 250, is a fixed or dedicated, application specific circuit, designed and having a corresponding logic gate layout to perform a specific function or algorithm, such as addition or multiplication. In addition, the various memory computational elements 250A and 250B may be implemented with various bit depths, such as RAM (having significant depth), or as a register, having a depth of 1 or 2 bits.

Forming the conceptual data and Boolean interconnect networks 240 and 210, respectively, the exemplary computation unit 200 also includes a plurality of input multiplexers 280, a plurality of input lines (or wires) 281, and for the output of the CU core 260 (illustrated as line or wire 270), a plurality of output demultiplexers 285 and 290, and a plurality of output lines (or wires) 291. Through the input multiplexers 280, an appropriate input line 281 may be selected for input use in data transformation and in the configuration and interconnection processes, and through the output demultiplexers 285 and 290, an output or multiple outputs may be placed on a selected output line 291, also for use in additional data transformation and in the configuration and interconnection processes.

In the exemplary embodiment, the selection of various input and output lines 281 and 291, and the creation of various connections through the interconnect (210, 220 and 240), is under control of control bits 265 from the computational unit controller 255, as discussed below. Based upon these control bits 265, any of the various input enables 251, input selects 252, output selects 253, MUX selects 254, DEMUX enables 256, DEMUX selects 257, and DEMUX output selects 258, may be activated or deactivated.

The exemplary computation unit 200 includes a computation unit controller 255 which provides control, through control bits 265, over what each computational element 250, interconnect (210, 220 and 240), and other elements (above) does with every clock cycle. Not separately illustrated, through the interconnect (210, 220 and 240), the various control bits 265 are distributed, as may be needed, to the various portions of the computation unit 200, such as the various input enables 251, input selects 252, output selects 253, MUX selects 254, DEMUX enables 256, DEMUX selects 257, and DEMUX output selects 258. The CU controller 295 also includes one or more lines 295 for reception of control (or configuration) information and transmission of status information.

As mentioned above, the interconnect may include a conceptual division into a data interconnect network 240 and a Boolean interconnect network 210, of varying bit widths, as mentioned above. In general, the (wider) data interconnection network 240 is utilized for creating configurable and reconfigurable connections, for corresponding routing of data and configuration information. The (narrower) Boolean interconnect network 210, while also utilized for creating configurable and reconfigurable connections, is utilized for control of logic (or Boolean) decisions of the various data flow graphs, generating decision nodes in such DFGs, and may also be used for data routing within such DFGs.

FIGS. 5A through 5E are block diagrams illustrating, in detail, exemplary fixed and specific computational elements, forming computational units, in accordance with the present invention. As will be apparent from review of these Figures, many of the same fixed computational elements are utilized, with varying configurations, for the performance of different algorithms.

FIG. 5A is a block diagram illustrating a four-point asymmetric finite impulse response (FIR) filter computational unit 300. As illustrated, this exemplary computational unit 300 includes a particular, first configuration of a plurality of fixed computational elements, including coefficient memory 305, data memory 310, registers 315, 320 and 325, multiplier 330, adder 335, and accumulator registers 340, 345, 350 and 355, with multiplexers (MUXes) 360 and 365 forming a portion of the interconnection network (210, 220 and 240).

FIG. 5B is a block diagram illustrating a two-point symmetric finite impulse response (FIR) filter computational unit 370. As illustrated, this exemplary computational unit 370 includes a second configuration of a plurality of fixed computational elements, including coefficient memory 305, data memory 310, registers 315, 320 and 325, multiplier 330, adder 335, second adder 375, and accumulator registers 340 and 345, also with multiplexers (MUXes) 360 and 365 forming a portion of the interconnection network (210, 220 and 240).

FIG. 5C is a block diagram illustrating a subunit for a fast Fourier transform (FFT) computational unit 400. As illustrated, this exemplary computational unit 400 includes a third configuration of a plurality of fixed computational elements, including coefficient memory 305, data memory 310, registers 315, 320, 325 and 385, multiplier 330, adder 335, and adder/subtractor 380, with multiplexers (MUXes) 360, 365, 390, 395 and 405 forming a portion of the interconnection network (210, 220 and 240).

FIG. 5D is a block diagram illustrating a complex finite impulse response (FIR) filter computational unit 440. As illustrated, this exemplary computational unit 440 includes a fourth configuration of a plurality of fixed computational elements, including memory 410, registers 315 and 320, multiplier 330, adder/subtractor 380, and real and imaginary accumulator registers 415 and 420, also with multiplexers (MUXes) 360 and 365 forming a portion of the interconnection network (210, 220 and 240).

FIG. 5E is a block diagram illustrating a biquad infinite impulse response (IIR) filter computational unit 450, with a corresponding data flow graph 460. As illustrated, this exemplary computational unit 450 includes a fifth configuration of a plurality of fixed computational elements, including coefficient memory 305, input memory 490, registers 470, 475, 480 and 485, multiplier 330, and adder 335, with multiplexers (MUXes) 360, 365, 390 and 395 forming a portion of the interconnection network (210, 220 and 240).

FIG. 6 is a block diagram illustrating, in detail, an exemplary multifunction adaptive computational unit 500 having a plurality of different, fixed computational elements, in accordance with the present invention. When configured accordingly, the adaptive computation unit 500 performs each of the various functions previously illustrated with reference to FIGS. 5A though 5E, plus other functions such as discrete cosine transformation. As illustrated, this multi-function adaptive computational unit 500 includes capability for a plurality of configurations of a plurality of fixed computational elements, including input memory 520, data memory 525, registers 530 (illustrated as registers 530A through 530Q), multipliers 540 (illustrated as multipliers 540A through 540D), adder 545, first arithmetic logic unit (ALU) 550 (illustrated as ALU_{—}1s 550A through 550D), second arithmetic logic unit (ALU) 555 (illustrated as ALU_{—}2s 555A through 555D), and pipeline (length 1) register 560, with inputs 505, lines 515, outputs 570, and multiplexers (MUXes or MXes) 510 (illustrates as MUXes and MXes 510A through 510KK) forming an interconnection network (210, 220 and 240). The two different ALUs 550 and 555 are preferably utilized, for example, for parallel addition and subtraction operations, particularly useful for radix 2 operations in discrete cosine transformation.

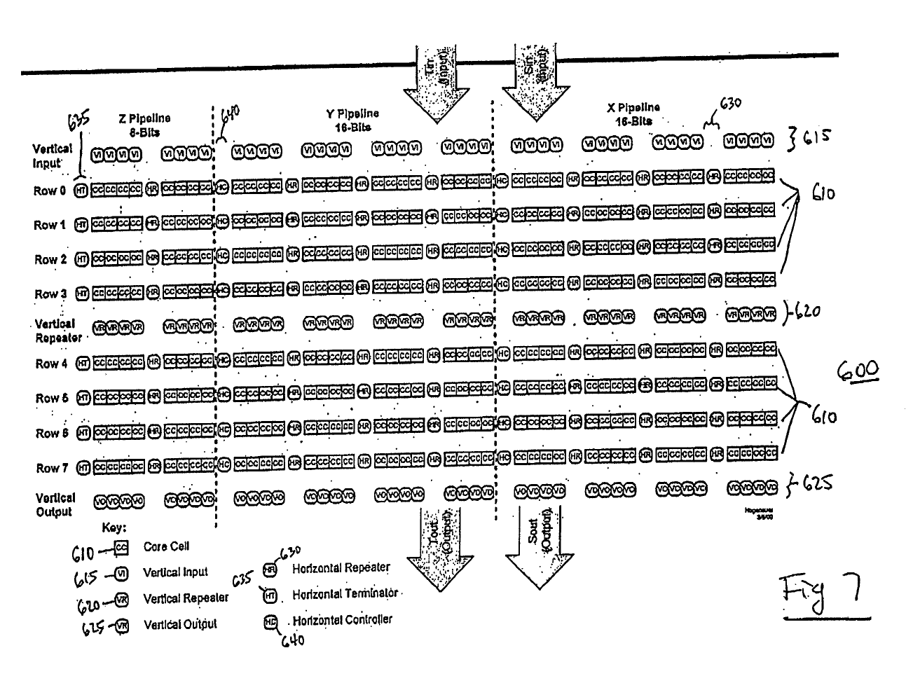

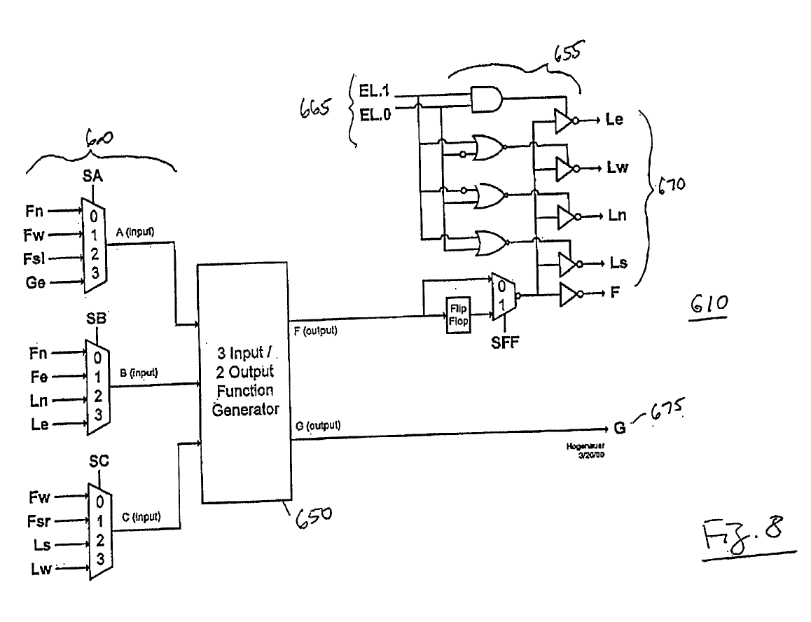

FIG. 7 is a block diagram illustrating, in detail, an exemplary adaptive logic processor (ALP) computational unit 600 having a plurality of fixed computational elements, in accordance with the present invention. The ALP 600 is highly adaptable, and is preferably utilized for input/output configuration, finite state machine implementation, general field programmability, and bit manipulation. The fixed computational element of ALP 600 is a portion (650) of each of the plurality of adaptive core cells (CCs) 610 (FIG. 8), as separately illustrated in FIG. 9. An interconnection network (210, 220 and 240) is formed from various combinations and permutations of the pluralities of vertical inputs (VIs) 615, vertical repeaters (VRs) 620, vertical outputs (VOs) 625, horizontal repeaters (HRs) 630, horizontal terminators (HTs) 635, and horizontal controllers (HCs) 640.

FIG. 8 is a block diagram illustrating, in greater detail, an exemplary core cell 610 of an adaptive logic processor computational unit 600 with a fixed computational element 650, in accordance with the present invention. The fixed computational element is a 3input-2 output function generator 550, separately illustrated in FIG. 9. The exemplary core cell 610 also includes control logic 655, control inputs 665, control outputs 670 (providing output interconnect), output 675, and inputs (with interconnect muxes) 660 (providing input interconnect).

FIG. 9 is a block diagram illustrating, in greater detail, an exemplary fixed computational element 650 of a core cell 610 of an adaptive logic processor computational unit 600, in accordance with the present invention. The fixed computational element 650 is comprised of a fixed layout of pluralities of exclusive NOR (XNOR) gates 680, NOR gates 685, NAND gates 690, and exclusive OR (XOR) gates 695, with three inputs 720 and two outputs 710. Configuration and interconnection is provided through MUX 705 and interconnect inputs 730.

As may be apparent from the discussion above, this use of a plurality of fixed, heterogeneous computational elements (250), which may be configured and reconfigured to form heterogeneous computation units (200), which further may be configured and reconfigured to form heterogeneous matrices 150, through the varying levels of interconnect (110, 210, 240 and 220), creates an entirely new class or category of integrated circuit, which may be referred to as an adaptive computing architecture. It should be noted that the adaptive computing architecture of the present invention cannot be adequately characterized, from a conceptual or from a nomenclature point of view, within the rubric or categories of FPGAs, ASICs or processors. For example, the non-FPGA character of the adaptive computing architecture is immediately apparent because the adaptive computing architecture does not comprise either an array of identical logical units, or more simply, a repeating array of any kind. Also for example, the non-ASIC character of the adaptive computing architecture is immediately apparent because the adaptive computing architecture is not application specific, but provides multiple modes of functionality and is reconfigurable in real-time. Continuing with the example, the non-processor character of the adaptive computing architecture is immediately apparent because the adaptive computing architecture becomes configured, to directly operate upon data, rather than focusing upon executing instructions with data manipulation occurring as a byproduct.

Based on the disclosure provided herein, it should be clear to a person of ordinary skill in the art that the present invention offers a number of advantages when used in implementing a hardware-based system. For example, using the adaptive computing architecture as described above, hardware resources within a system can be utilized or allocated more efficiently and intelligently. For instance, when a specific function is not needed at a particular point in time, the associated hardware resources, including the matrices 150 and their constituent computation units 200 and computational elements 250, used to implement that specific function can be re-allocated and re-configured to implement one or more other functions which can benefit from the additional hardware resources.

The additional hardware resources can be utilized in a number of ways. For example, additional functional units which are used to carry out another function can be added by re-allocating and re-configuring some or all of the additional hardware resources to increase the parallel processing power thereby allowing faster execution of such function.

Consider a cdma2000 or W-CDMA cellular phone for example. At power-up, a single searcher is typically used to perform system acquisition and the majority of the communication or radio functions of the cellular phone are idle. The implementation of a single searcher is commonly known in the art. Now consider a cellular phone implemented with the adaptive computing architecture described herein. Hardware resources, which would have been needed if the idle communication or radio functions were active, can be re-allocated to perform the system acquisition function at a time when system acquisition is needed, such as when the cellular phone is initially powered up. That is, additional instances of the searcher can be implemented to provide more parallel processing power thereby allowing the system acquisition function to be performed faster. The number of additional instances of the searcher to be implemented depends on the amount of hardware resources which are available and/or other factors such as design choice and system constraints and requirements etc.

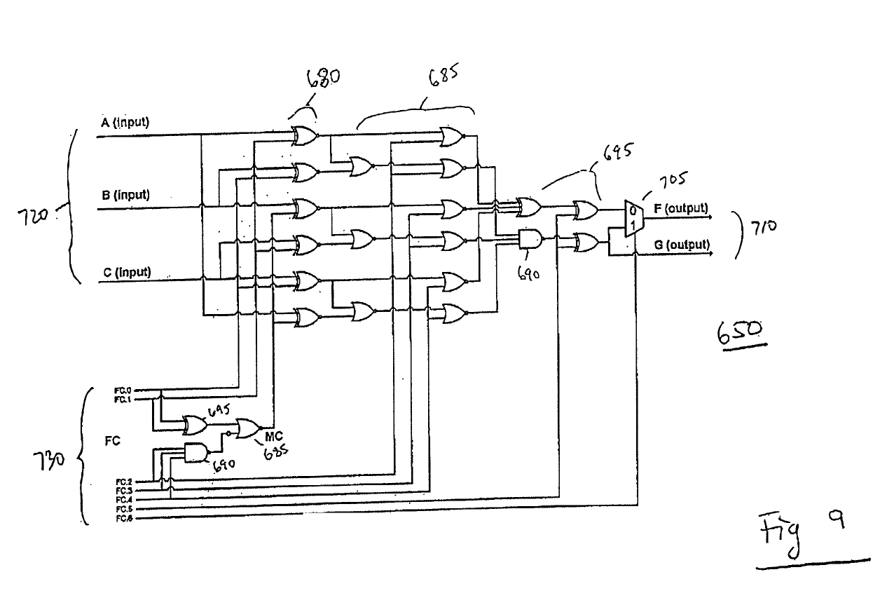

Referring to FIG. 10, for example, at the time the cellular phone is initially powered up, three instances of the searcher 1002, 1004 and 1006 are implemented to speed up the system acquisition process. Subsequently, when the system acquisition process is completed, some or all of the hardware resources which were used to implement the system acquisition function may be de-allocated and then re-allocated and re-configured to implement one or more communication functions 1008 which are to become active shortly.

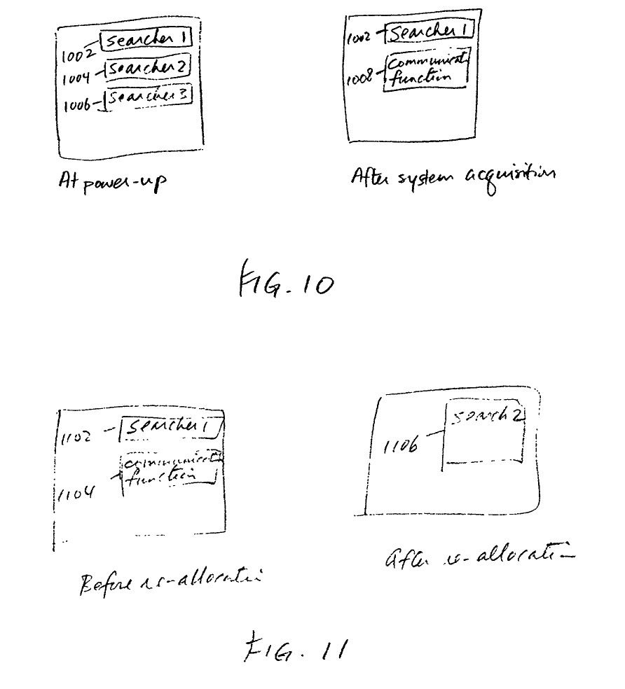

In another example, some or all of the additional hardware resources can be re-allocated and re-configured to provide a modified or alternative implementation of an existing function. Again, consider the cellular phone implemented with the adaptive computing architecture described herein. The additional hardware resources can be used to implement a modified or alternative searcher which can perform the system acquisition function in a faster manner. Referring to FIG. 11, for example, hardware resources for the searcher 1102 and the communication function 1104 are re-allocated and re-configured to implement the searcher 1106. In this case, instead of using the additional hardware resources to implement multiple instances of the searcher (which is a viable alternative), the additional hardware resources are used to implement one instance of a modified or alternative searcher. If sufficient hardware resources are available, the modified or alternative searcher may provide better performance than a number of smaller searchers operating in parallel. Likewise, the choice as to whether to use the additional hardware resources to implement one instance of a modified or alternative searcher depends on the amount of hardware resources which are available and/or other factors such as design choice and system constraints and requirements etc.

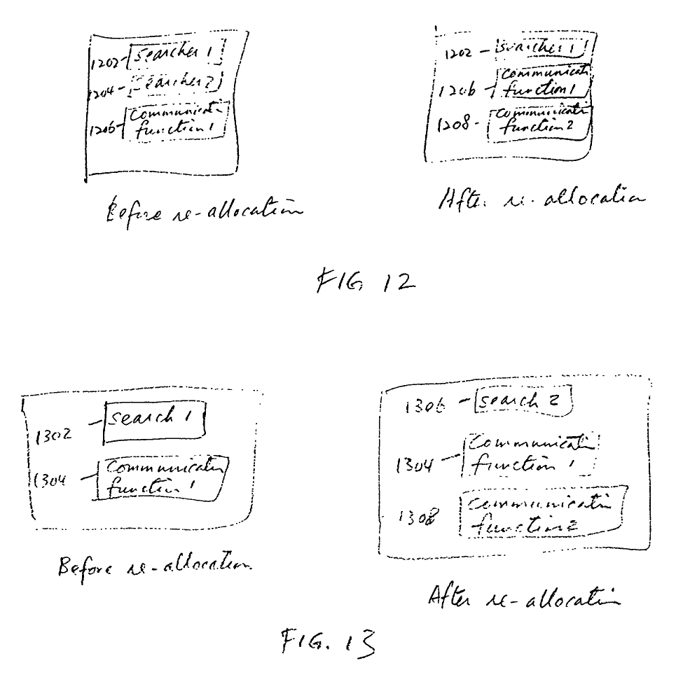

In yet another example, some or all of the additional hardware resources can be re-allocated and re-configured to provide an additional function which is implemented subject to availability of the hardware resources. Such additional function may be an independent function that is to be added to the system or an optional or supplemental function that works in cooperation with another existing function. Similarly, the additional hardware resources may be re-allocated and re-configured as either multiple functional units or a single functional unit to provide the additional function. Referring to FIG. 12, for example, hardware resources for the searcher 1204 are de-allocated and re-allocated and reconfigured to implement the additional communication function 1208. The choice as to how to use the additional hardware resources to implement the additional function depends on the amount of hardware resources which are available and/or other factors such as design choice and system constraints and requirements etc.

In a further example, some or all of the hardware resources being used to implement an existing function may be de-allocated and then re-allocated and reconfigured to implement an additional function and the existing function in a different manner. Again, using the cellular phone implemented with the adaptive computing architecture described herein as an example. Referring to FIG. 13, for example, hardware resources may be initially allocated to implement one version of the searcher 1302 which has a higher level of performance. When the need to implement another function 1308 arises, some of the previously allocated hardware resources may be de-allocated and then re-allocated and re-configured to implement this other function 1308, and the remaining hardware resources previously allocated to implement one version of the searcher 1302 may be re-allocated and re-configured to implement another version of the searcher 1306 which has a lower level of performance. While a cellular phone having a searcher is used herein as an example, it should be clear to a person of ordinary skill in the art that the present invention can be similarly applied to other types of communication devices having a system acquisition functionality including, for example, communication devices which utilize Bluetooth and 802.11 technology.

Other advantages of the present invention may be further apparent to those of skill in the art. For mobile communications, for example, hardware acceleration for one or two algorithmic elements has typically been confined to infrastructure base stations, handling many (typically 64 or more) channels. Such an acceleration may be cost justified because increased performance and power savings per channel, performed across multiple channels, results in significant performance and power savings. Such multiple channel performance and power savings are not realizable, using prior art hardware acceleration, in a single operative channel mobile terminal (or mobile unit). In contrast, however, through use of the present invention, cost justification is readily available, given increased performance and power savings, because the same IC area may be configured and reconfigured to accelerate multiple algorithmic tasks, effectively generating or bringing into existence a new hardware accelerator for each next algorithmic element.

Yet additional advantages of the present invention may be further apparent to those of skill in the art. The ACE 100 architecture of the present invention effectively and efficiently combines and maximizes the various advantages of processors, ASICs and FPGAs, while minimizing potential disadvantages. The ACE 100 includes the programming flexibility of a processor, the post-fabrication flexibility of FPGAs, and the high speed and high utilization factors of an ASIC. The ACE 100 is readily reconfigurable, in real-time, and is capable of having corresponding, multiple modes of operation. In addition, through the selection of particular functions for reconfigurable acceleration, the ACE 100 minimizes power consumption and is suitable for low power applications, such as for use in hand-held and other battery-powered devices.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A communication device configured to perform a plurality of functions, comprising:
a plurality of heterogeneous computational elements; and
an interconnection network coupled to the plurality of heterogeneous computational elements, the interconnection network operative to configure the plurality of heterogeneous computational elements;
wherein a first group of heterogeneous computational elements is configurable to form a first functional unit to implement a system acquisition function;
wherein a second group of heterogeneous computational elements is configurable to form a second functional unit to implement a communication function; and
wherein if the communication function is idle, one or more of the second group of heterogeneous computational elements are reconfigurable by the interconnection network to implement the system acquisition function.

2. The communication device of claim 1 wherein the first functional unit is a searcher.

3. The communication device of claim 1 wherein the communication device is a cellular phone, a Bluetooth communication device or a 802.11 communication device.

4. The communication device of claim 1 wherein if the communication function is idle, the one or more of the second group of heterogeneous computational elements are reconfigurable to implement the system acquisition function by forming one or more additional instances of the first functional unit.

5. The communication device of claim 1 wherein if the communication function is idle, one or more of the first group of heterogeneous computational elements and the one or more of the second group of heterogeneous computational elements are reconfigurable to form a single functional unit to implement the system acquisition function.

6. The communication device of claim 1 wherein if the communication function is idle, the one or more of the second group of heterogeneous computational elements are reconfigurable by the interconnection network to implement one or more of the plurality of functions other than the communication function.

7. The communication device of claim 1 wherein if a third function is to be implemented, one or more of the first group of heterogeneous computational elements and/or the one or more of the second group of heterogeneous computational elements are reconfigurable by the interconnection network to implement the third function.

8. A communication device comprising:
a plurality of reconfigurable matrices, the plurality of reconfigurable matrices including a plurality of heterogeneous computational units, each heterogeneous computational unit having a plurality of fixed computational elements, the plurality of fixed computational elements including a first computational element having a first architecture and a second computational element having a second architecture, the first architecture distinct from the second architecture, the plurality of heterogeneous computational units coupled to an interconnect network and reconfigurable in response to configuration information; and
a matrix interconnection network coupled to the plurality of reconfigurable matrices, the matrix interconnection network operative to reconfigure the plurality of reconfigurable matrices in response to the configuration information for a plurality of operating modes;
wherein a first group of heterogeneous computational units is reconfigurable to form a first functional unit to implement a system acquisition mode;
wherein a second group of heterogeneous computational units is reconfigurable to form a second functional unit to implement a communication mode;
wherein if the communication mode is idle, one or more of the second group of heterogeneous computational units are reconfigurable to implement the system acquisition mode.

9. The communication device of claim 8 wherein the first functional unit is a searcher.

10. The communication device of claim 8 wherein the communication device is a cellular phone, a Bluetooth communication device or a 802.11 communication device.

11. The communication device of claim 8 wherein if the communication mode is idle, the one or more of the second group of heterogeneous computational units are reconfigurable to implement the system acquisition mode by forming one or more additional instances of the first functional unit.

12. The communication device of claim 8 wherein if the communication mode is idle, one or more of the first group of heterogeneous computational units and the one or more of the second group of heterogeneous computational units are reconfigurable to form a single functional unit to implement the system acquisition mode.

13. The communication device of claim 8 wherein if the communication mode is idle, the one or more of the second group of heterogeneous computational units are reconfigurable to implement one or more of the plurality of operating modes other than the communication mode.

14. The communication device of claim 8 wherein if a third operating mode is to be implemented, one or more of the first group of heterogeneous computational units and/or the one or more of the second group of heterogeneous computational units are reconfigurable to implement the third operating mode.

15. A communication device comprising:
a plurality of heterogeneous computational elements, the plurality of heterogeneous computational elements including a first computational element and a second computational element, the first computational element having a first fixed architecture of a plurality of fixed architecture and the second computational element having a second fixed architecture of the plurality of fixed architectures, the first fixed architecture being different than the second fixed architecture, and the plurality of fixed architectures including functions for memory, addition, multiplication, complex multiplication, subtraction, configuration, reconfiguration, control, input, output, and field programmability; and
an interconnection network coupled to the plurality of heterogeneous computational elements, the interconnection network operative to configure the plurality of heterogeneous computational elements;
wherein a first group of heterogeneous computational elements is reconfigurable to form a first functional unit to implement a system acquisition function;
wherein a second group of heterogeneous computational elements is reconfigurable to form a second functional unit to implement a communication function; and
wherein if the communication function is idle, one or more of the second group of heterogeneous computational elements are reconfigurable by the interconnection network to implement the system acquisition function.

16. The communication device of claim 15 wherein the first functional unit is a searcher.

17. The communication device of claim 15 wherein the communication device is a cellular phone, a Bluetooth communication device or a 802.11 communication device.

18. The communication device of claim 15 wherein if the communication function is idle, the one or more of the second group of heterogeneous computational elements are reconfigurable to implement the system acquisition function by forming one or more additional instances of the first functional unit.

19. The communication device of claim 15 wherein if the communication function is idle, one or more of the first group of heterogeneous computational elements and the one or more of the second group of heterogeneous computational elements are reconfigurable to form a single functional unit to implement the system acquisition function.

20. The communication device of claim 15 wherein if the communication function is idle, the one or more of the second group of heterogeneous computational elements are reconfigurable by the interconnection network to implement one or more of the plurality of functions other than the communication function.

21. The communication device of claim 15 wherein if a third function is to be implemented, one or more of the first group of heterogeneous computational elements and/or the one or more of the second group of heterogeneous computational elements are reconfigurable by the interconnection network to implement the third function.

22. A communication device comprising:
a plurality of heterogeneous computational elements, the plurality of heterogeneous computational elements including a first computational element and a second computational element, the first computational element having a first fixed architecture and the second computational element having a second fixed architecture, the first fixed architecture being different than the second fixed architecture; and
an interconnection network coupled to the plurality of heterogeneous computational elements, the interconnection network operative to configure a first group of heterogeneous computational elements to form a first functional unit for a first functional mode of a plurality of functional modes, in response to first configuration information, and the interconnection network further operative to reconfigure a second group of heterogeneous computational elements to form a second functional unit for a second functional mode of the plurality of functional modes, in response to second configuration information, the first functional mode being different than the second functional mode, and the plurality of functional modes including system acqusition operations, linear algorithmic operations, non-linear algorithmic operations, finite state machine operations, memory operations, and bit-level manipulations;
wherein if the second functional mode is idle, one or more of the second group of heterogeneous computational units are reconfigurable to implement the first functional mode.

23. The communication device of claim 22 wherein the first functional mode is the system acquisition operations and the first functional unit is a searcher.

24. The communication device of claim 22 wherein the communication device is a cellular phone, a Bluetooth communication device or a 802.11 communication device.

25. The communication device of claim 22 wherein if the second functional mode is idle, the one or more of the second group of heterogeneous computational elements are reconfigurable to implement the first functional mode by forming one or more additional instances of the first functional unit.

26. The communication device of claim 22 wherein if the second functional mode is idle, one or more of the first group of heterogeneous computational elements and the one or more of the second group of heterogeneous computational elements are reconfigurable to form a single functional unit to implement the first functional mode.

27. The communication device of claim 22 wherein if the second functional mode is idle, the one or more of the second group of heterogeneous computational elements are reconfigurable by the interconnection network to implement one or more of the plurality of functional modes other than the second functional mode.

28. The communication device of claim 22 wherein if a third functional mode is to be implemented, one or more of the first group of heterogeneous computational elements and/or the one or more of the second group of heterogeneous computational elements are reconfigurable by the interconnection network to implement the third functional mode.

29. A method for allocating hardware resources within a communication device, the hardware resources including a plurality of heterogeneous computational elements, the method comprising:
in response to first configuration information, configuring a first group of heterogeneous computational elements to form a first functional unit to implement a system acquisition function and configuring a second group of heterogeneous computational elements to form a second functional unit to implement a communication function; and
in response to second configuration information, reconfiguring one or more of the second group of heterogeneous computational elements to implement the system acquisition function.

30. The method of claim 29 wherein the first functional unit is a searcher.

31. The method of claim 29 wherein the communication device is a cellular phone, a Bluetooth communication device or a 802.11 communication device.

32. The method of claim 29 wherein the second configuration information is generated when the communication function is idle.

33. The method of claim 29 wherein in response to the second configuration information, the one or more of the second group of heterogeneous computational elements are reconfigured to form one or more additional instances of the first functional unit to implement the system acquisition function.

34. The method of claim 29 wherein in response to the second configuration information, one or more of the first group of heterogeneous computational elements and the one or more of the second group of heterogeneous computational elements are reconfigured to form a single functional unit to implement the system acquisition function.

35. The method of claim 29 further comprising:
in response to third configuration information, reconfiguring one or more of the first group of heterogeneous computational elements and/or the one or more of the second group of heterogeneous computational elements to implement a third function.

36. A method for allocating hardware resources within a communication device, the hardware resources including a plurality of heterogeneous computational elements, the method comprising:
in response to first configuration information, configuring a first group of heterogeneous computational elements to implement a system acquisition function; and
in response to second configuration information, reconfiguring one or more of the first group of heterogeneous computational elements to implement a communication function.

37. The method of claim 36 wherein in response to the first configuration information, the first group of heterogeneous computational elements is configured to form one or more functional units to implement the system acquisition function.

38. The method of claim 37 wherein each of the one or more functional units is a searcher.

39. The method of claim 36 wherein the first configuration information is generated when the system acquisition function is needed and the second configuration information is generated when the system acquisition function is completed.

40. The method of claim 29 wherein the communication device is a cellular phone, a Bluetooth communication device or a 802.11 communication device.
